(19) United States
(12) Patent Application Publication
(10) Pub. No.: US 2025/0252388 A1
(43) Pub. Date: Aug. 7, 2025

(54) METHODS AND SYSTEMS FOR CHECKOUT INTERFACE WITH LOW LATENCY DISPLAY OF DELIVERY DATE

(71) Applicant: SHOPIFY INC., Ottawa (CA)

(72) Inventors: Fekadeab Dejene, Nepean (CA); Peter Moon, Etobicoke (CA)

(21) Appl. No.: 18/434,149

(22) Filed: Feb. 6, 2024

(51) Int. Cl. G06Q 10/0834; G06N 20/00; G06Q 30/0601

(52) U.S. Cl. CPC G06Q 10/08345; G06N 20/00; G06Q 30/0641

(57) ABSTRACT

Methods and systems for presenting dynamically generated estimates in a checkout interface are described. A geolocation estimate is obtained based on an IP address associated with a user device. A machine learning model is used to obtain candidate estimates for candidate regions overlapping with an accuracy region defined about the geolocation estimate. The candidate estimates are stored in a cache. Responsive to receiving, from the user device, input indicating a desired region, a candidate estimate is retrieved from the cache for an identified candidate region matching the desired region. The retrieved candidate estimate is communicated to the user device, to cause the user device to present the at least one retrieved candidate estimate in a checkout interface.

### FIELD

The present disclosure relates to methods and systems related to a user interface for a checkout transaction. In particular the present disclosure relates to methods and systems for a checkout interface that presents a dynamic delivery date estimate with little or no latency.

### BACKGROUND

Conventionally, a checkout interface may provide a user with a rough estimate of the delivery date, based on broad factors such as whether or not a product is currently in stock or whether a delivery is domestic or international. Generally, the delivery date estimate that is presented to the user at checkout is imprecise and at times inaccurate. The lack of accuracy and precision not only prevents the user from making an informed decision (e.g., selecting the shipping option that fits their time and budget constraints), the functionality of the checkout interface is also limited (e.g., inability of the checkout interface to offer a split cart option that groups products by delivery date).

### SUMMARY

A machine learning (ML) model may help to provide more accurate delivery date estimates at checkout. However, attempts to use ML to provide more accurate and precise delivery estimates tend to be hampered by latency. The time required to execute a ML model to generate a predicted delivery date can be significant (e.g., 1 s or more). This latency problem is worsened when the ML model requires specific input data, such as the user's desired shipping address (e.g., the ZIP code of the shipping address may be required as input to the ML model), before a prediction can be generated. This means the ML model can only be executed to generate a prediction after the user enters their information, causing an unavoidable delay in providing the delivery date estimate. This latency is propagated to other functions of the checkout interface that rely on the delivery date estimate (e.g., the checkout interface cannot offer an option for guaranteed delivery by a certain time until a delivery date estimate is generated). The result is that the user is presented with an incomplete checkout interface for a significant length of time, leading to a slow and disjointed user experience.

In various examples, the present disclosure provides a technical solution for providing a checkout interface that presents a delivery date estimate with little or no latency after a user's desired shipping address is obtained (e.g., via user input or obtained by other means). In examples disclosed herein, geolocation based on the user's Internal Protocol (IP) address (e.g., IP address of the user device or IP address of the network host that the device is connected to) is used to determine one or more candidate delivery regions (which are estimates of what delivery region the user is currently located in), prior to obtaining the user's desired shipping address. For example, such geolocation may be performed while the user is still at the product page. The candidate delivery region(s) are inputted to a ML system to generate candidate delivery estimates that are cached. When the user's desired shipping address is obtained at a checkout interface, the appropriate candidate delivery estimate can be retrieved from cache and presented in the checkout in a near instantaneous manner. This provides a technical advantage in that the cache is populated with suitable candidate delivery estimates ahead of time, so that a delivery estimate can be retrieved from cache and presented in the checkout interface with little or no latency after obtaining the user's desired shipping address. Additionally, other functionality of the checkout interface that may depend on a delivery date estimate may be enabled with little or no latency. Thus, an improved user interface may be provided.

Examples disclosed herein provide improvements in computer operations in that appropriate real-time data can be more efficiently generated to populate a delivery estimate cache, without generating excessive and/or irrelevant data. Because delivery conditions can change rapidly (e.g., weather-related, capacity related, etc.) and even hourly, it is important that the delivery estimates retrieved from the cache are up-to-date. This means that it is not efficient or even possible to pre-generate delivery estimates for all possible permutations and store the estimates in a long-term memory for long-term use. Further, it is not practical or efficient to generate up-to-date delivery estimates for all possible delivery destinations for even one product (let alone multiple products), even if only done on an hourly basis. Even if generation of such a large number of delivery estimates was possible (which may not be the case using existing technology), the vast majority of the delivery estimates would be very unlikely to be used, meaning a significant amount of computer resources would be wasted in generating these estimates. Examples of the present disclosure provide a technique for determining the candidate delivery regions that are used for delivery estimates, using IP-based geolocation, which helps to avoid such wasting of computing resources.

In an example aspect, the present disclosure describes a computer system including a cache; and a processing unit configured to execute computer-readable instructions to cause the computer system to: obtain a geolocation estimate based on an IP address associated with a user device; obtain, using a machine learning model, one or more candidate estimates for at least one candidate region overlapping with an accuracy region defined about the geolocation estimate; store the obtained one or more candidate estimates in the cache; responsive to receiving, from the user device, input indicating a desired region, retrieve from the cache at least one candidate estimate for an identified candidate region matching the desired region; and communicate the at least one retrieved candidate estimate to the user device, to cause the user device to present the at least one retrieved candidate estimate in a checkout interface.

In an example of the preceding example computer system, the processing unit may be configured to execute the instructions to further cause the computer system to determine the candidate regions by: defining the accuracy region about the geolocation estimate by using the geolocation estimate as a center of the accuracy region and an accuracy margin extending from the center of the accuracy region to define a boundary of the accuracy region; and identifying, as the at least one candidate region, at least one predefined region, from a set of predefined regions, that overlaps with the accuracy region.

In an example of the preceding example computer system, the processing unit may be configured to execute the instructions to further cause the computer system to identify the at least one predefined region that overlaps with the accuracy region by: identifying the at least one predefined region, from a set of predefined regions, whose boundary falls within or intersects with the boundary of the accuracy region.

In an example of a preceding example computer system, the processing unit may be configured to execute the instructions to further cause the computer system to identify the at least one predefined region that overlaps with the accuracy region by: identifying the at least one predefined region, from a set of predefined regions, whose representative location falls within the accuracy region.

In an example of a preceding example computer system, the processing unit may be configured to execute the instructions to further cause the computer system to obtain the geolocation estimate by obtaining, from a third-party service provider, the geolocation estimate with the accuracy margin assigned by the third-party service provider.

In an example of a preceding example computer system, the accuracy margin may be representative of a confidence level or accuracy of the geolocation estimate.

In an example of any of the preceding example computer systems, the geolocation estimate may be obtained prior to presentation of the checkout interface on the user device.

In an example of any of the preceding example computer systems, the geolocation estimate may be obtained during or prior to presentation of a product page on the user device, and the retrieved at least one candidate estimate presented in the checkout interface may be related to of a product presented on the product page.

In an example of any of the preceding example computer systems, the processing unit may be configured to execute the instructions to further cause the computer system to obtain the one or more candidate estimates for the at least one candidate region by executing the machine learning system by: inputting to the machine learning system a set of input data including data representing the at least one candidate region; and obtaining a prediction from the machine learning system including the one or more candidate estimates.

In an example of the preceding example computer system, the processing unit may be configured to execute the instructions to further cause the computer system to obtain candidate estimates for two or more candidate regions by: identifying a higher priority candidate region from the two or more candidate regions; and executing the machine learning system to obtain at least one candidate estimate for the higher priority candidate region prior to obtaining at least one candidate estimate for a remainder of the two or more candidate regions.

In an example of any of the preceding example computer systems, the processing unit may be configured to execute the instructions to further cause the computer system to obtain at least one candidate estimate by: retrieving, from the cache, the at least one candidate estimate, the retrieved at least one candidate estimate being previously obtained using the machine learning system.

In an example of any of the preceding example computer systems, the one or more candidate estimates may be one or more candidate delivery estimates, the at least one candidate region may be at least one candidate delivery region, and the desired region may be a desired delivery region.

In another example aspect, the present disclosure describes a computer implemented method including: obtaining a geolocation estimate based on an IP address associated with a user device; obtaining, using a machine learning model, one or more candidate estimates for at least one candidate region overlapping with an accuracy region defined about the geolocation estimate; storing the obtained one or more candidate estimates in a cache; responsive to receiving, from the user device, input indicating a desired region, retrieving from the cache at least one candidate estimate for an identified candidate region matching the desired region; and communicating the at least one retrieved candidate estimate to the user device, to cause the user device to present the at least one retrieved candidate estimate in a checkout interface.

In an example of the preceding example method, the method may include determining the candidate regions by: defining the accuracy region about the geolocation estimate by using the geolocation estimate as a center of the accuracy region and an accuracy margin extending from the center of the accuracy region to define a boundary of the accuracy region; and identifying, as the at least one candidate region, at least one predefined region, from a set of predefined regions, that overlaps with the accuracy region.

In an example of the preceding example method, identifying the at least one predefined region that overlaps with the accuracy region may include: identifying the at least one predefined region, from a set of predefined regions, whose boundary falls within or intersects with the boundary of the accuracy region.

In an example of a preceding example method, identifying the at least one predefined region that overlaps with the accuracy region may include: identifying the at least one predefined region, from a set of predefined regions, whose representative location falls within the accuracy region.

In an example of a preceding example method, obtaining the geolocation estimate may include: obtaining, from a third-party service provider, the geolocation estimate with the accuracy margin assigned by the third-party service provider.

In an example of a preceding example method, the accuracy margin may be representative of a confidence level or accuracy of the geolocation estimate.

In an example of any of the preceding example methods, the geolocation estimate may be obtained prior to presentation of the checkout interface on the user device.

In an example of any of the preceding example methods, the geolocation estimate may be obtained during or prior to presentation of a product page on the user device, and the retrieved at least one candidate estimate presented in the checkout interface may be related to of a product presented on the product page.

In an example of a preceding example method, obtaining the one or more candidate estimates for the at least one candidate region may include executing the machine learning system by: inputting to the machine learning system a set of input data including data representing the at least one candidate region; and obtaining a prediction from the machine learning system including the one or more candidate estimates.

In an example of the preceding example method, candidate estimates may be obtained for two or more candidate regions by: identifying a higher priority candidate region from the two or more candidate regions; and executing the machine learning system to obtain at least one candidate estimate for the higher priority candidate region prior to obtaining at least one candidate estimate for a remainder of the two or more candidate regions.

In an example of any of the preceding example methods, the method may include obtaining at least one candidate estimate by: retrieving, from the cache, the at least one candidate estimate, the retrieved at least one candidate estimate being previously obtained using the machine learning system.

In an example of any of the preceding example methods, the one or more candidate estimates may be one or more candidate delivery estimates, the at least one candidate region may be at least one candidate delivery region, and the desired region may be a desired delivery region.

In another example aspect, the present disclosure describes a non-transitory computer readable medium having instructions stored thereon, wherein the instructions are executable by a processing unit of a computer system to cause the computer system to: obtain a geolocation estimate based on an IP address associated with a user device; obtain, using a machine learning model, one or more candidate estimates for at least one candidate region overlapping with an accuracy region defined about the geolocation estimate; store the obtained one or more candidate estimates in the cache; responsive to receiving, from the user device, input indicating a desired region, retrieve from the cache at least one candidate estimate for an identified candidate region matching the desired region; and communicate the at least one retrieved candidate estimate to the user device, to cause the user device to present the at least one retrieved candidate estimate in a checkout interface.

In some examples, the computer-readable medium may store instructions that, when executed by the processor of the computing system, cause the computing system to perform any of the example aspect of the methods described above.

### BRIEF DESCRIPTION OF THE DRAWINGS

Reference will now be made, by way of example, to the accompanying drawings which show example embodiments of the present application, and in which:

FIG. 1 is a block diagram of an example e-commerce platform, which may be an example implementation of the examples disclosed herein;

FIG. 2 is an example homepage of an administrator, which may be accessed via the e-commerce platform of FIG. 1;

FIG. 3 is a block diagram of a simplified neural network, which may be used in examples of the present disclosure;

FIG. 4 is a block diagram of an example computing system, which may be used to implement examples of the present disclosure;

FIG. 5 is a block diagram of another example e-commerce platform, which may be an example implementation of the examples disclosed herein;

FIG. 6 is a block diagram of an example checkout engine and delivery date estimator, which may be used to implement examples of the present disclosure;

FIG. 7 illustrates an example of determining candidate delivery regions, in accordance with examples of the present disclosure; and

FIG. 8 is a flowchart illustrating an example method for presenting a checkout interface with low latency display of a dynamic delivery date estimate, in accordance with examples of the present disclosure.

Similar reference numerals may have been used in different figures to denote similar components.

### DETAILED DESCRIPTION

In various examples, the present disclosure describes methods and systems for providing a checkout interface in which delivery date estimates are presented with little or no latency, for example immediately presented after obtaining a user's desired shipping address. An appropriate delivery date estimate may be retrieved from a delivery estimate cache with little or no latency. Examples of the present disclosure enable appropriate real-time data to be generated, using a machine learning system, to populate the delivery estimate cache, without generating excessive and/or irrelevant data. Because delivery conditions can change rapidly (e.g., weather-related, capacity related, etc.) and even hourly, it is important that the delivery estimates retrieved from the cache are up-to-date. This means that it is not possible to pre-generate delivery estimates for all possible permutations and store the estimates in a long-term memory for long-term use. It is also not practical (and likely not possible using existing technology) to generate delivery estimates for all possible delivery destinations for a product on an hourly basis. Not only would doing so consume large amounts of computing resources, the vast majority of the generated delivery estimates would be very unlikely to be used, thus a significant amount of computer resources would be wasted in generating these estimates.

In examples described herein, methods and systems for populating a delivery estimate cache with up-to-date delivery estimates, which can then be presented in a checkout interface, are described. A user's estimated geolocation (e.g., based on the IP address of the user device) is used to identify candidate delivery region(s) (which are estimate(s) of the user's likely desired shipping address), and delivery estimates may be generated only for those candidate delivery region(s), thus reducing the number of delivery estimates that need to be generated and improving overall computing efficiency.

By efficiently populating the delivery estimate cache with up-to-date delivery estimates, a more streamlined user experience can be provided. The user may be provided with full and accurate information on the checkout interface with little or no latency after the user inputs their desired shipping address. Additionally, this enables the other functionality of the checkout interface to be enabled as soon as the desired shipping address is entered, rather than introducing further delay.

In some examples, delivery estimates stored in the delivery estimate cache may be retrieved and presented in checkout interfaces to different users (e.g., if the delivery estimate generated for one user is for the same delivery region as a different user, then that delivery estimate may be retrieved from the delivery estimate cache instead of being generated again). This may help to further improve overall system efficiency because delivery estimates can be reused, thus saving computing resources.

Examples of the present disclosure may provide a checkout interface that presents a dynamic delivery date estimate with little or no latency (e.g., delivery date estimate is presented immediately after user input of a desired shipping address). Examples of the present disclosure may be implemented in an e-commerce platform, discussed below. However, it should be understood that the example e-commerce platform is provided only for the purpose of illustration and is not intended to be limiting. Further, it should be understood that the present disclosure may be implemented in other contexts, and is not necessarily limited to implementation in an e-commerce platform. For example, the methods and systems disclosed herein may be provided by an online checkout service that is not necessarily part of an e-commerce platform. In another example, an online store, which may not be hosted by an e-commerce platform (i.e. the online store is a standalone online store) may provide an online checkout service. Other such possibilities are contemplated within the scope of the present disclosure.

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

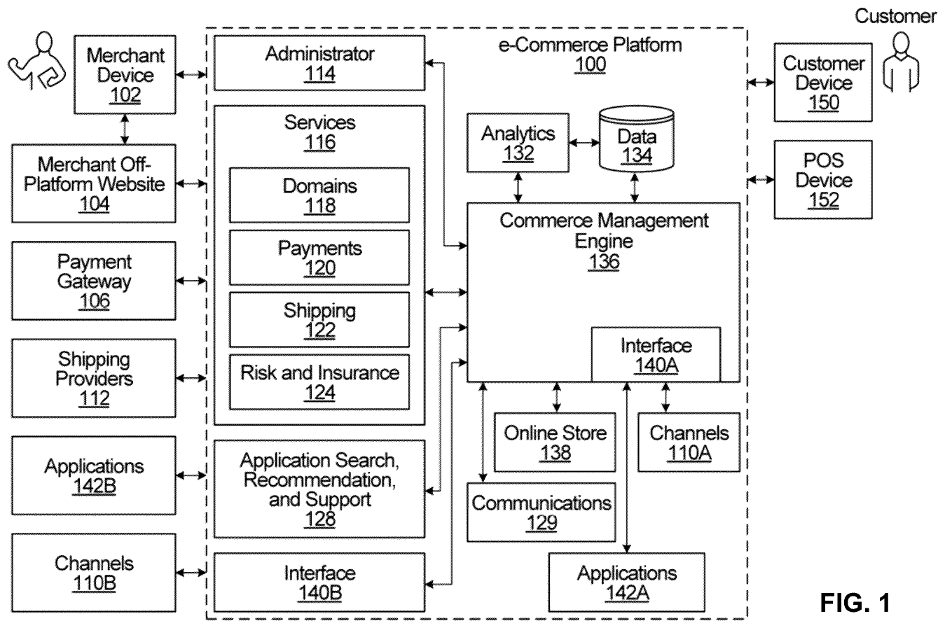

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 1, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

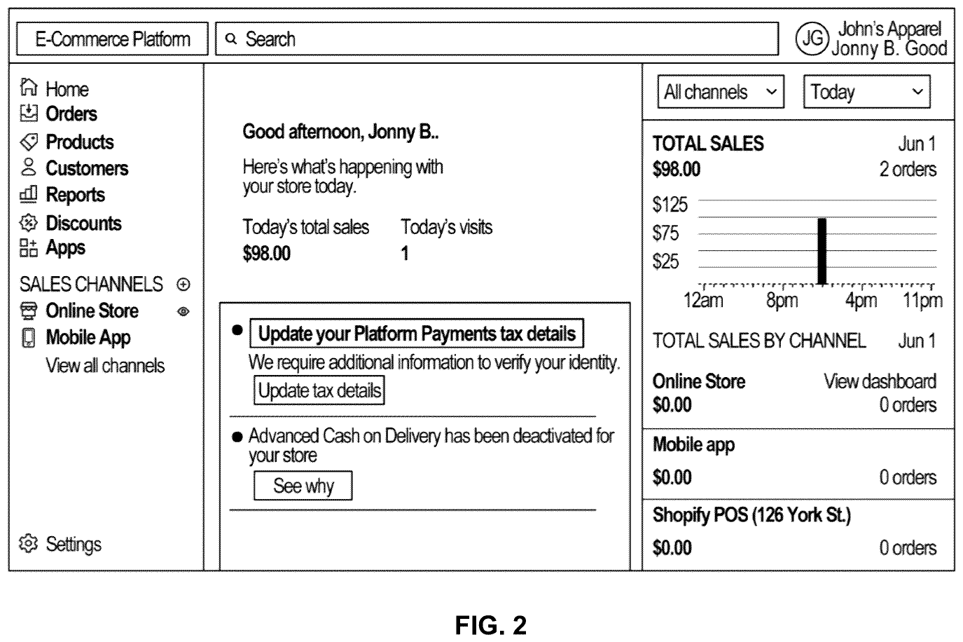

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalogue, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services, for example, in an analytics facility 132. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales) (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

In some examples, the applications 142A-B may include an application that enables a user interface (UI) to be displayed on the customer device 150. In particular, the e-commerce platform 100 may provide functionality to enable content associated with an online store 138 to be displayed on the customer device 150 via a UI.

As will be discussed further below, examples of the present disclosure may be implemented using machine learning (ML) models. To assist in understanding the present disclosure, some concepts relevant to neural networks and ML are now discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publically-available text corpuses may be, e.g., fine-tuned by further training using the complete works of Shakespeare as training data samples (e.g., where the intended use of the ML model is generating a scene of a play or other textual content in the style of Shakespeare).

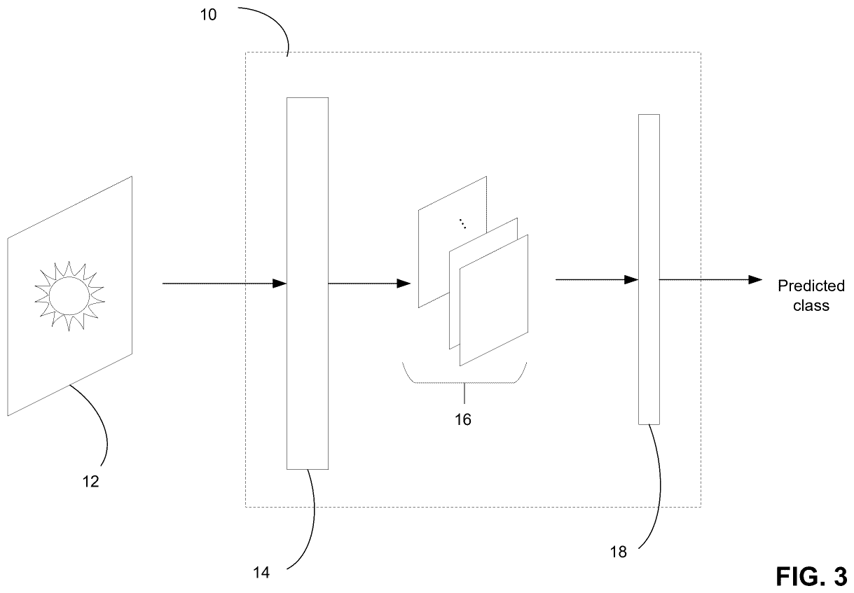

FIG. 3 is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Although a CNN is described as an example of a neural network that may be used as a ML model, this is not intended to be limiting. As will be discussed further below, examples of the present disclosure may be implemented using one or more ML models (e.g., implemented using one or more DNNs).

A computing system may access a remote ML model (e.g., a cloud-based ML model) via a software interface (e.g., an application programming interface (API)). Additionally or alternatively, such a remote ML model may be accessed via a network such as, for example, the Internet. In some implementations such as, for example, potentially in the case of a cloud-based ML model, a remote ML model may be hosted by a computer system which may include a plurality of cooperating (e.g., cooperating via a network) computer systems such as may be in, for example, a distributed arrangement. Notably, a remote ML model may employ a plurality of processors (e.g., hardware processors such as, for example, processors of cooperating computer systems). Indeed, processing of inputs by a ML model having many model parameters may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

In some examples, two or more ML models may be implemented in a ML system, and outputs generated by the two or more ML models may be combined to provide one predicted output. In a multi-model ML system, each ML model within the ML system may be trained independently or may be trained together (e.g., the entire ML system may be trained together end-to-end). Additionally or alternatively, each ML model in the ML system may be independently pre-trained, then the entire ML system may be fine-tuned end-to-end. Further details of an example ML system which may be used to implement examples of the present disclosure will be provided further below.

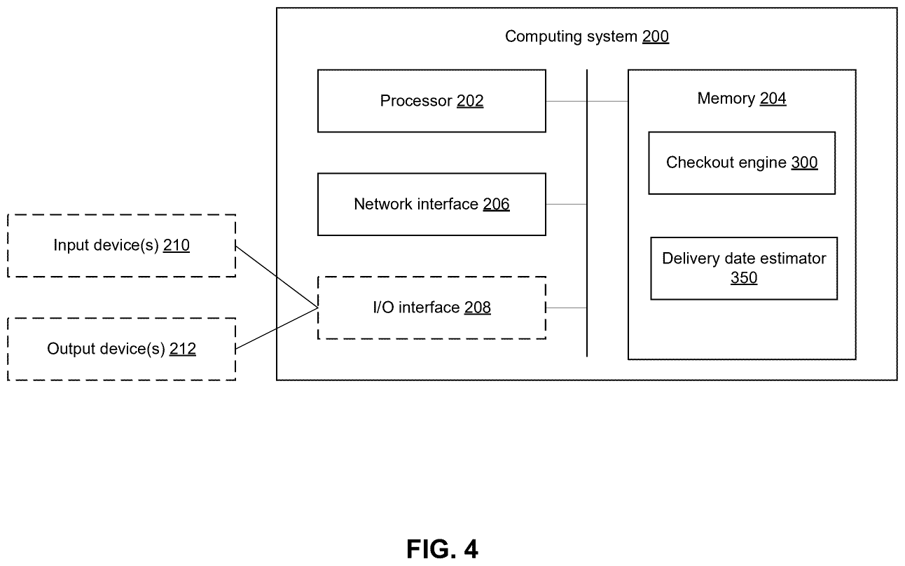

FIG. 4 illustrates an example computing system 200, which may be used to implement examples of the present disclosure. For example, the computing system 200 may be used to implement some components of the e-commerce platform 100 such as a checkout engine 300 and/or a delivery date estimator 350. Additionally or alternatively, one or more instances of the example computing system 200 may be employed to provide functionality of the checkout engine 300, delivery date estimator 350 and/or the e-commerce platform 100. For example, a plurality of instances of the example computing system 200 may cooperate to provide a resource pool for a virtual machine that provides functionality disclosed herein. It should also be understood that the computing system 200 may communicate with a remote system (which may be remote from the e-commerce platform 100) to access at least some functionality of the checkout engine 300 and/or delivery date estimator 350. For example, the delivery date estimator 350 may, in some implementations, be implemented using a ML system hosted by a remote server.

The example computing system 200 includes at least one processing unit and at least one physical memory 204. The processing unit may be a hardware processor 202 (simply referred to as processor 202). The processor 202 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to cause the computing system 200 to carry out examples of the methods, functionalities, systems and modules disclosed herein.

The computing system 200 may also include at least one network interface 206 for wired and/or wireless communications with an external system and/or network (e.g., an intranet, the Internet, a P2P network, a WAN and/or a LAN). The network interface 206 may enable the computing system 200 to carry out communications (e.g., wireless communications) with systems external to the computing system 200, such as a ML model residing on a remote system.

The computing system 200 may optionally include at least one input/output (I/O) interface 208, which may interface with optional input device(s) 210 and/or optional output device(s) 212. Input device(s) 210 may include, for example, buttons, a microphone, a touchscreen, a keyboard, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

A computing system, such as the computing system 200 of FIG. 2, may access a remote system (e.g., a cloud-based system) to communicate with a ML model hosted on the remote system such as, for example, using an API call. As previously mentioned, in some examples at least some functionality of the delivery date estimator 350 may be provided by a remote ML system instead. The API call may include an API key to enable the computing system to be identified by the remote system. The API call may also include an identification of the ML model or ML system to be accessed. The API call may include a set of input data to the ML model or ML system, which may be forward propagated through the ML model or ML system in order to generate an output (also referred to as a prediction or inference) that is communicated back to the computing system 200. In other examples, the computing system 200 may provide input data to the ML model or ML system without requiring an API call. For example, the input data could be sent to a remote ML model or ML system via a network such as, for example, in a message (e.g., in a payload of a message).

In the example of FIG. 4, the computing system 200 may store in the memory 204 computer-executable instructions, which may be executed by a processing unit such as the processor 202, to implement one or more embodiments disclosed herein. For example, the memory 204 may store instructions for implementing a checkout engine 300, details of which will be discussed further below. In some examples, the memory 204 may also store instructions for implementing a delivery date estimator 350 (e.g., may store parameters of one or more ML models of the delivery date estimator 350). In some examples, the delivery date estimator 350 may not be a component of the computing system 200 and may instead be hosted at a remote server, which may be accessed by the computing system 200.

In some examples, the computing system 200 may be a server of an online platform that provides the checkout engine 300 (and optionally the delivery date estimator 350) as a web-based or cloud-based service that may be accessible by a user device (e.g., via communications over a wireless network). Other such variations may be possible without departing from the subject matter of the present application.

As will be discussed further below, examples of the present disclosure may provide a checkout interface that presents a delivery date estimate with little or no latency (e.g., delivery date estimate is presented immediately after user input of a desired shipping address), which may be implemented on the e-commerce platform 100. The e-commerce platform 100 could implement this functionality for any of a variety of different applications, examples of which are described elsewhere herein.

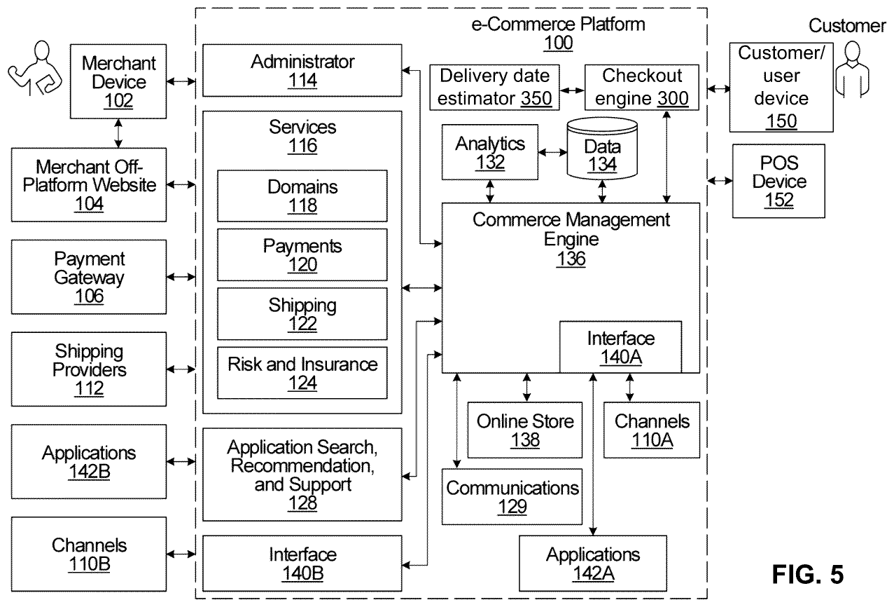

FIG. 5 illustrates the e-commerce platform 100 of FIG. 1 but including a checkout engine 300 and a delivery date estimator 350. The checkout engine 300 and the delivery date estimator 350 are examples of computer-implemented systems that may be used to implement the functionality described herein for use by the e-commerce platform 100, the customer device 150 and/or the merchant device 102. The computing system 200 of FIG. 4 may be an example hardware embodiment that may be used to implement the checkout engine 300 and/or delivery date estimator 350 in the e-commerce platform 100. As illustrated in FIG. 5, the customer device 150 may also be referred to as a user device 150.

Although the checkout engine 300 and delivery date estimator 350 are illustrated as distinct components of the e-commerce platform 100 in FIG. 5, this is only an example. At least some functionality that is described herein as being provided by the checkout engine 300 and/or the delivery date estimator 350 may additionally or alternatively be provided by another component residing within or external to the e-commerce platform 100. For example, either or both of the applications 142A-B may provide at least some of the functionality described herein to make it available to customers and/or to merchants. Furthermore, in some embodiments, the commerce management engine 136 may provide some of the functionality disclosed herein. The location of the checkout engine 300 and the delivery date estimator 350 may be implementation specific. In some implementations, the checkout engine 300 and/or the delivery date estimator 350 may be provided at least in part by an e-commerce platform (such as the e-commerce platform 100 of FIG. 5), for example as a core function of the e-commerce platform or as an application or service supported by or communicating with the e-commerce platform. In some examples, the checkout engine 300 and/or the delivery date estimator 350 may be implemented as a stand-alone service to clients such as a user device 150 or a merchant device 102. In some examples, at least a portion of such an engine could be implemented in the merchant device 102 and/or in the user device 150. For example, the user device 150 could store and run at least some components of the checkout engine 300 and/or the delivery date estimator 350 locally as a software application. As well, in some examples, the delivery date estimator 350 may be hosted remotely rather than being a component of the e-commerce platform 100.

In some examples, a user interface for a checkout transaction (which may be simply referred to as a checkout interface) may be presented to the customer via the user device 150. More generally, the checkout interface may be presented to a user (who may be a customer) via a user device 150 (which may also be referred to as a customer device 150). The user device 150 may receive instructions from the checkout engine 300, for example, to cause the checkout interface to be presented and/or to cause the checkout interface to be updated (e.g., to update the checkout interface in order to present a delivery date estimate). In some examples, the checkout engine 300 may generate the checkout interface and transmit the checkout interface to be presented by the user device 150. In other examples, the checkout interface may be generated by the user device 150 (e.g., a checkout interface functionality may be implemented at the user device instead of or in addition to implementation at the e-commerce platform 100) and the user device 150 may receive instructions from the checkout engine 300 to populate and/or update the checkout interface, for example with delivery date estimates generated by the checkout engine 300.

It should be understood that although some embodiments described herein may be implemented in association with an e-commerce platform, such as (but not limited to) the e-commerce platform 100, the embodiments described herein are not limited to e-commerce platforms. For example, the embodiments may be implemented in a standalone application or any other computing system.

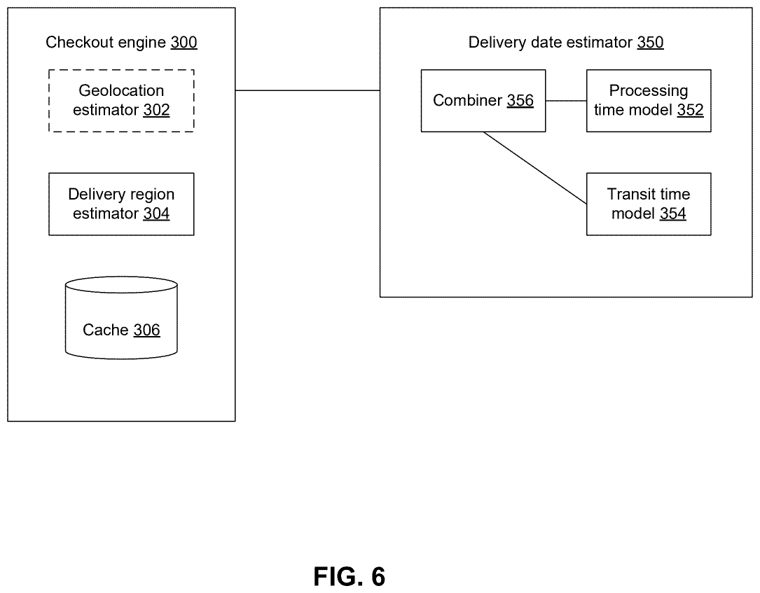

FIG. 6 is a block diagram illustrating an example implementation of the checkout engine 300 and the delivery date estimator 350. Although the checkout engine 300 and the delivery date estimator 350 have been illustrated with certain components, this is not intended to be limiting. It should be understood that a functionality or operation described as being performed using a particular component may instead be performed using a different component, or may be performed by another system external to the checkout engine 300 and delivery date estimator 350 (e.g., performed by another component of the e-commerce platform 100 or performed by a third-party service provider).

The checkout engine 300 and delivery date estimator 350 may be used to obtain and store candidate delivery estimates prior to the user inputting their actual shipping address in a checkout interface. For example, while a user is still viewing a product page for a product or when the user places a product in their virtual cart but before checkout, candidate delivery estimates may be obtained and stored in a cache. Then, when the user later inputs a shipping address in the checkout interface, the appropriate delivery estimate may be retrieved from the cache and presented in the checkout interface with little or no latency.

In the example shown, the checkout engine 300 includes an optional geolocation estimator 302, a delivery region estimator 304 and a cache 306. As will be discussed further below, the geolocation estimator 302 is used to estimate a geolocation of a user device 150, the delivery region estimator 304 is used to identify candidate delivery region(s) and the cache 306 is used to locally store candidate delivery estimates.

The geolocation estimator 302 performs operations to estimate a geolocation based on an IP address associated with the user device 150 (which may be an IP address of the user device 150 itself or an IP address of the host server that the user device 150 is connected to, for example). Various techniques may be used by the geolocation estimator 302 to estimate the geolocation (e.g., in latitude and longitude) based on the IP address associated with the user device 150 (e.g., using a geolocation database). For example, the geolocation estimator 302 may use a portion of the IP address or the whole IP address to lookup an estimated geolocation using a database, registry or other reference. Various geolocation techniques using the IP address may be performed, such as those described in https://en.wikipedia.org/wiki/Internet_geolocation, incorporated herein by reference in its entirety; and/or in accordance with the RFC 9092 standard, which is incorporated herein by reference in its entirety.

In some examples, the checkout engine 300 may not include the geolocation estimator 302. Instead, the checkout engine 300 may obtain the IP address associated with the user device 150, provide the IP address to a geolocation service (which may be provided by another component of the e-commerce platform 100 or a third-party service provider) and receive the geolocation estimate. The geolocation service may use any of the IP address-based geolocation techniques described above, such as based on the RFC 9092 standard, performing a lookup using a database or registry, etc. The geolocation estimate (whether generated by the geolocation estimator 302 of the checkout engine 300 or obtained from another geolocation service) may be obtained with an accuracy margin. The accuracy margin represents the expected accuracy of the geolocation estimate. The accuracy margin may be expressed in various ways, such as a confidence level, an error margin or an accuracy radius. An accuracy radius may be a distance measure (e.g., 100 meters, 1 mile, etc.) of a radius about the geolocation estimate that the true geolocation is expected to fall inside. An error margin may be an error margin in the latitude and/or longitude of the geolocation estimate (e.g., +/−0.1° in latitude and longitude). Regardless of how the accuracy margin is expressed, the accuracy margin may be used to define the accuracy region about the geolocation estimate.

The delivery region estimator 304 uses the geolocation estimate and accuracy margin to define an accuracy region. The accuracy region is a geographical region that is defined about the geolocation estimate and that has a dimension based on the accuracy margin. For example, if the accuracy margin is an accuracy radius, the accuracy region may be a circular area centered on the geolocation estimate and having a radius equal to the distance of the accuracy radius (e.g., if the accuracy radius is 1 mile, then the accuracy region is a circular area 1 mile in radius and centered on the geolocation estimate). In another example, if the accuracy margin is an error margin, the accuracy region may be a rectangular area centered on the geolocation estimate and bounded by the error margins in latitude and longitude (e.g., if the geolocation estimate is 40° N and 70° W with an error margin of +/−0.1° in latitude and longitude, then the accuracy region is a rectangular area bounded by 40.1° N, 39.9° N, 70.1° W and 69.9° W). It should be understood that the accuracy region may be any shape and may depend on how the accuracy margin is expressed.

In some examples, if the geolocation estimate is not provided with an accuracy margin, the delivery region estimator 304 may use a default accuracy margin to define the accuracy region. The default accuracy margin may be single value (e.g., an accuracy radius of 1 mile may be used by default). In some examples, there may be different default accuracy margins used by the delivery region estimator 304 (e.g., depending on the country, state or province that the geolocation estimate falls within, depending on the approximate demographics of the geolocation estimate, depending on how delivery regions are defined, etc.). For example, if the geolocation estimate falls within a more populated state, it may be expected that the geolocation estimate is more accurate and the delivery region estimator 304 may select a first default accuracy margin having a smaller value; on the other hand, if the geolocation estimate falls within a less populated state, it may be expected that the geolocation estimate is less accurate and the delivery region estimator 304 may select a second default accuracy margin having a larger value.

After defining the accuracy region, the delivery region estimator 304 identifies one or more candidate delivery regions overlapped by the accuracy region. A candidate delivery region is an estimate of a delivery region that the user is likely to use as the desired delivery region at checkout. Delivery regions may be defined according to a delivery system, such as ZIP3 regions defined by the first three digits of a ZIP code used in the United States, or forward sortation areas defined by the first three characters of a postal code used in Canada. Any delivery region that is overlapped by (i.e., fully or partially within) the accuracy region may be identified by the delivery region estimator 304 as a candidate delivery region.

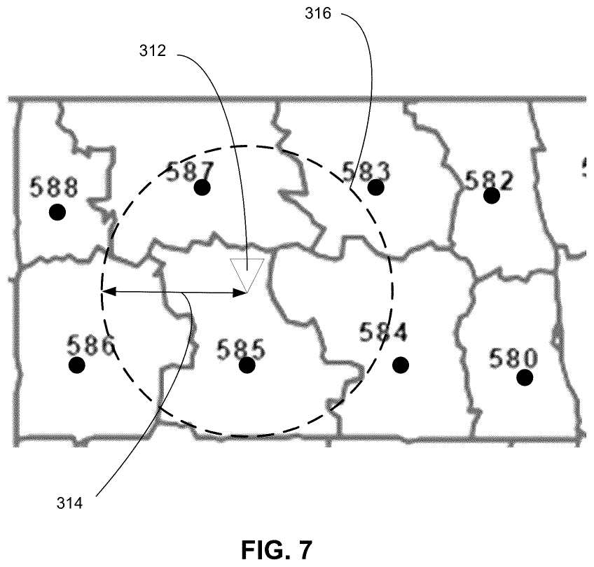

Different approaches may be used by the delivery region estimator 304 to identify the candidate delivery regions, some of which are now discussed with reference to FIG. 7.

FIG. 7 illustrates an example geolocation estimate 312 on a map that shows delivery regions, specifically ZIP3 regions int his example. The geolocation estimate 312 has an accuracy margin, in this case an accuracy radius 314. An accuracy region 316 is defined about the geolocation estimate 312, using the accuracy radius 314 to define the boundary of the accuracy region 316.

In a first approach, the delivery region estimator 304 may access a database defining the boundaries of the delivery regions and identify all delivery regions that overlap with the accuracy region 316. In this example, the ZIP3 regions corresponding to ZIP3 codes 583, 584, 585, 586 and 587 are all overlapped by the accuracy region 316 and thus may be identified as candidate delivery regions. In a second approach, the delivery region estimator 304 may use a representative location of each delivery region (e.g., centroid location of each delivery region) and identify all delivery regions whose representative locations are overlapped by (i.e., fall within or touches) the accuracy region 316. In this example, the representative location of each ZIP3 region is illustrated by a black circle. The representation locations of the ZIP3 regions corresponding to ZIP3 codes 585 and 587 are overlapped by the accuracy region 316 and thus ZIP3 regions for 585 and 587 may be identified as candidate delivery regions. In yet a third approach (not illustrated in FIG. 7), a country may be partitioned into a grid of regularly shaped cells and the delivery region(s) covered by each cell may be identified beforehand. Then the delivery region estimator 304 may identify cell(s) overlapped by the accuracy region 316 and further identify the delivery region(s) covered by the overlapped cell(s). This approach may be similar to the first approach described above, however it may be computationally less expensive to identify the regularly shaped cell(s) overlapped by the accuracy region 316 rather than the irregularly shaped delivery region(s) overlapped by the accuracy region 316.

Although some example approaches that may be used by the delivery region estimator 304 are described above, these are not intended to be limiting or mutually exclusive. For example, the delivery region estimator 304 may use multiple different approaches and identify as candidate delivery region(s) the union of delivery region(s) identified using the different approaches or identify as candidate delivery region(s) only delivery region(s) identified using at least two of the different approaches. In another example, the delivery region estimator 304 may use the first approach for an irregularly shaped delivery region and use the second approach for a more regularly shaped delivery region.

Reference is again made to FIG. 6. The candidate delivery region(s) identified by the delivery region estimator 304 may be used to obtain candidate delivery estimates. The checkout engine 300 may query the cache 306 to determine if there is any suitable candidate delivery estimate already in the cache 306. For example, if another user in a particular one of the candidate delivery regions had previously browsed the same product in the last hour, candidate delivery estimate(s) may already have been generated and cached for at least that particular candidate delivery region. If a suitable candidate delivery estimate is found to be already in the cache 306, then that candidate delivery estimate may be reused and the delivery date estimator 350 need not be used to generate candidate delivery estimate(s) for that candidate delivery region, thus saving computing resources.

If candidate delivery estimate(s) for a candidate delivery region are not found in the cache 306, the checkout engine 300 provides each candidate delivery region to the delivery date estimator 350.

The delivery date estimator 350 in this example includes two ML models, namely a processing time model 352 and a transit time model 354, which generate a processing time estimate and a transit time estimate, respectively. The outputs from the processing time model 352 and transit time model 354 are combined by a combiner 356 to provide a delivery date estimate to the checkout engine 300.

The processing time model 352 (which may be implemented using a suitable DNN) is trained (e.g., using supervised learning) to predict the time from an order being created (e.g., an order for the product may be created when a checkout transaction is completed) to the product being handed off to a carrier. The input data to the processing time model 352 may include a day of the week the order was created, an indicator of any upcoming holidays (e.g., a binary indicator whether there is a holiday within the next three days of the order being created), an hour the order was created, an order volume in the past week, and an average processing time in the past week. Some of the input data may be provided by the checkout engine 300. For example, because the delivery date estimator 350 is being used to generate delivery estimates prior to an actual checkout transaction, the checkout engine 300 may provide the current day of the week, indicator of upcoming holiday and current hour as approximators of the checkout day and hour. Some of the input data may be obtained by the delivery date estimator 350 from other databases, such as the data facility 134 and/or analytics facility 132 of the e-commerce platform 100. For example, the checkout engine 300 may provide information about the product to be delivered (e.g., including an identifier of the product and/or an identifier of the online store providing the product), which the delivery date estimator 350 may use to query the data facility 134 and/or analytics facility 132 for statistics about the order volume and average processing time of the product or online store in the past week.

The processing time model 352 is executed, which forward propagates the input data through the processing time model 352 to generate as output a predicted processing time (which may be expressed in hours or days, for example). The predicted processing time may be outputted with a confidence score representing the confidence or certainty associated with the prediction by the processing time model 352.

The transit time model 354 (which may be implemented using another suitable DNN) is trained (e.g., using supervised learning) to predict the time from the carrier receiving the product to the product arriving at a shipping address. The input data to the transit time model 354 may include a candidate delivery region (e.g., a candidate ZIP3), a product fulfilment location (e.g., the location of a warehouse storing the product), a day of the week the carrier received the product, a mail class, an average carrier transit time in the past week and a median carrier transit time in the past week. Some of the input data may be provided by the checkout engine 300, such as the candidate delivery region and a current day of the week (which may be used as an approximator for the day of the week the carrier received the product). Some of the input data may be obtained by the delivery date estimator 350 from other databases, such as the data facility 134 and/or analytics facility 132 of the e-commerce platform 100. For example, the checkout engine 300 may provide information about the product to be delivered (e.g., including an identifier of the product and/or an identifier of the online store providing the product), which the delivery date estimator 350 may use to query the data facility 134 and/or analytics facility 132 for information about the fulfilment location, the typical mail class offered by the online store and statistics about the carrier transit time of the carrier typically used by the online store in the past week.

The transit time model 354 is executed, which forward propagates the input data through the transit time model 354 to as output a predicted transit time (which may be expressed in hours or days, for example). The predicted transit time may be outputted with a confidence score representing the confidence or certainty associated with the prediction by the transit time model 354.

The processing time model 352 and the transit time model 354 may be executed in parallel and independently of each other. The outputs from the processing time model 352 and the transit time model 354 are combined by the combiner 356 (e.g., summed together) to obtain a candidate delivery date estimate for the candidate delivery region. If the predictions from the processing time model 352 and the transit time model 354 include confidence scores, the combiner 356 may compute a combined confidence score (e.g., the combined confidence score may be an average of the confidence scores from each model 352, 354, or the combined confidence score may be the least confident of the confidence scores from each model 352, 354, among other possibilities). In some examples, the delivery date estimator 350 may be used to generate multiple candidate delivery date estimates for a single candidate delivery region, for example by using different mail classes in the input data.

The checkout engine 300 provides each candidate delivery region to the delivery date estimator 350 and receives candidate delivery estimate(s) for each candidate delivery region. Each candidate delivery estimate is stored in the cache 306 together with at least some of the data used to generate that estimate. For example, a candidate delivery estimate may be stored in the cache 306 together with an identifier of the online store, the candidate delivery region, the fulfilment location and the mail class. The data stored with the candidate delivery estimate may enable reuse of the candidate delivery estimate as described previously. The data stored with each candidate delivery estimate may not contain any private or sensitive information, thus enabling the candidate delivery estimate to be reused and presented to another user without violating any user privacy. Additionally, the input data used by the delivery date estimator 350 to generate each candidate delivery estimate may be general enough to enable reuse of the candidate delivery estimate. Each candidate delivery estimate may also be stored with a timestamp indicating the time that estimate was generated. This may enable the cache 306 to automatically discard any estimate that has become stale (e.g., a candidate delivery estimate that is one hour old or older may be automatically flushed from the cache 306), thus ensuring that estimates stored in the cache 306 are up-to-date.

When the user navigates to the checkout interface and an indicator of the desired delivery region is received by the checkout engine 300 (e.g., the user inputs their shipping address including the full ZIP code or the shipping address is auto-populated using a user's passkey), the checkout engine 300 retrieves from the cache 306 the candidate delivery estimate(s) for the candidate delivery region that matches the actual desired delivery region. Since the cache 306 is local to the checkout engine 300, retrieval of the candidate delivery estimate(s) and presentation of the candidate delivery estimate(s) in the checkout interface can happen with little or no latency once the desired delivery region is received. The user may then complete the checkout transaction using the checkout interface as usual.

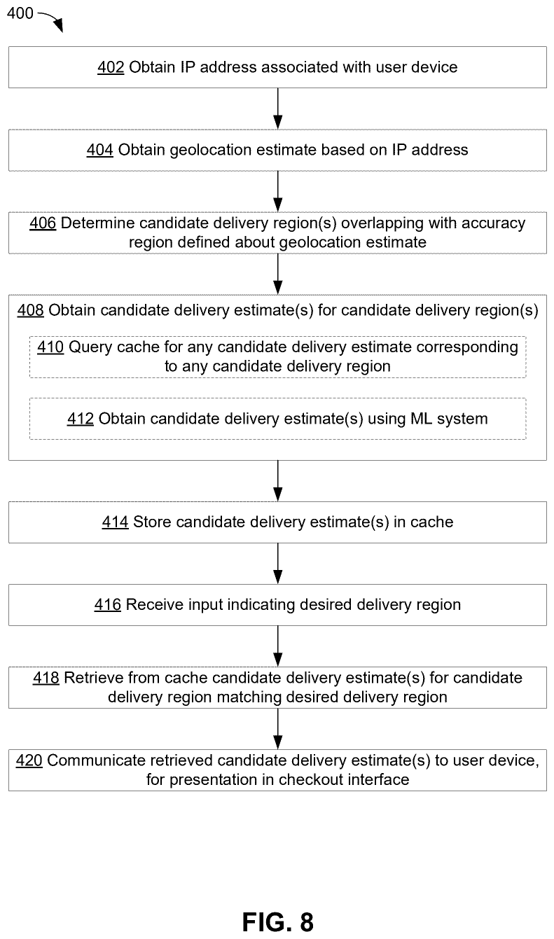

FIG. 8 is a flowchart of an example method 400 for an example embodiment of the present disclosure, which may be performed by a computing system, in accordance with examples of the present disclosure. For example, a processing unit of a computing system (e.g., the processor 202 of the computing system 200 of FIG. 2) may execute instructions (e.g., instructions of the checkout engine 300) to cause the computing system to carry out the example method 400. The method 400 may, for example, be implemented by an online platform or a server.

In some examples, the method 400 may begin when a user is viewing a product page using a user device or has placed a product in a virtual cart (e.g., the method 400 may be triggered or initiated in response to a product viewing event or virtual cart event). In some examples, the method 400 may begin prior to the user inputting a desired shipping address in a checkout interface, and may begin prior to presenting the checkout interface on the user device.

At an operation 402, an IP address associated with the user device is obtained. For example, the IP address of the user device may be obtained, the IP address of the router connected to the user device may be obtained or the IP address of the host server connected to the user device may be obtained. For example, a request (such as a SQL request) may be sent by the computing system to obtain the IP address.

At an operation 404, a geolocation estimate is obtained based on the IP address associated with the user device. For example, a geolocation estimate may be generated using the optional geolocation estimator 302 of the checkout engine 300. In another example, a geolocation estimate may be obtained by providing the obtained IP address to a third-party service provider providing a geolocation service and obtaining the geolocation estimate from the third-party geolocation service provider. Various IP address-based geolocation techniques may be used, For example, a portion of the IP address or the whole IP address may be used to lookup an estimated geolocation using a database, registry or other reference. Various geolocation techniques using the IP address may be performed, such as those described in https://en.wikipedia.org/wiki/Internet_geolocation; and/or in accordance with the RFC 9092 standard. As previously discussed, an accuracy margin may be obtained together with the geolocation estimate. For example, the third-party service provider may assign an accuracy margin (e.g., an accuracy radius, confidence level, error margin, etc.) to the geolocation estimate. Generally, the accuracy margin may be representative of a confidence level or accuracy of the geolocation estimate. In some examples, the accuracy margin may be a default value and there may be different default values for different categories of geolocation estimates (e.g., depending on the country, state, etc. that the geolocation estimate falls within).

At an operation 406, one or more candidate delivery regions are determined. The candidate delivery region(s) are estimate(s) of the delivery region(s) that are likely to be the desired delivery region (e.g., the actual ZIP3 region of the shipping address that will be inputted at the checkout interface). For example, the delivery region estimator 304 described previously may be used to perform the operation 406. The operation 406 may include defining an accuracy and the candidate delivery region(s) may be determined by determining delivery region(s) that are overlapped with the accuracy region.

As discussed previously, the accuracy region may be defined about the geolocation estimate by using the geolocation estimate as a center as the center of the accuracy region and extending the accuracy margin from the center to define the boundary of the accuracy region. For example, if the accuracy margin is an accuracy radius, the accuracy region may be a circular area centered on the geolocation estimate and having a radius equal to the distance of the accuracy radius; if the accuracy margin is an error margin, the accuracy region may be a rectangular area centered on the geolocation estimate and bounded by the error margins in latitude and longitude; or the accuracy region may be any regular or irregular shape depending on how the accuracy margin is represented.

Having defined the accuracy region, the computing system may identify which delivery region(s) from a set of predefined delivery regions (e.g., predefined ZIP3 regions, predefined forward sortation areas, etc.) overlap with the accuracy region. Various techniques may be used to identify the overlapped delivery region(s) as the candidate delivery region(s). For example, any delivery region(s) whose boundaries fall within or intersect with the boundary of the accuracy region may be identified as candidate delivery region(s). In another example, each predefined delivery region may be represented by a representative location within the delivery region (e.g., a centroid of the delivery region). Then any delivery region(s) whose centroids fall within the accuracy region may be identified as candidate delivery region(s). Other techniques and combinations thereof may be used to identify the candidate delivery region(s).

At an operation 408, candidate delivery estimates are obtained for the candidate delivery region(s). The operation 408 may include performing an operation 410 to query a cache for a candidate delivery estimate and/or an operation 412 to obtain a candidate delivery estimate from a ML model or ML system.

At the operation 410, a cache is queried for any candidate delivery estimate(s) corresponding to at least one candidate delivery region. For example, as previously described, the checkout engine 300 may store, in a local cache 306, candidate delivery estimates that were previously generated by the delivery date estimator 350. Each candidate delivery estimate may be stored with metadata such as a product identifier (e.g., identifying the product for which the candidate delivery estimate was generated), online store identifier (e.g., identifying the online store for which the candidate delivery estimate was generated), candidate delivery region identifier (e.g., identifying the candidate delivery region for which the candidate delivery estimate was generated), confidence score (e.g., representing the confidence or certainty of the candidate delivery estimate) and timestamp (e.g., indicating the time when the candidate delivery estimate was originally generated), etc. This metadata may enable the candidate delivery estimate to be reused, such as when a candidate delivery estimate is required for another user having the same candidate delivery region as a previous user. If a given candidate delivery region matches a candidate delivery region of a cached candidate delivery estimate, and the cached candidate delivery estimate is not stale (e.g., the timestamp is still current, such as within the past hour) then the ML model or ML system may not need to be executed for the given candidate delivery region since a candidate delivery estimate is already stored in the cache for the given candidate delivery region. In this way, the computing resources that would be required to execute the ML model or ML system may be saved.

At the operation 412, one or more candidate delivery estimates may be obtained using a ML model or ML system. The operation 412 may be performed for any candidate delivery region for which a cached candidate delivery estimate cannot be found. For example, the delivery date estimator 350, including ML models such as the processing time model 352 and the transit time model 354, may be used to generate candidate delivery estimates. A set of input data (e.g., the input data to each of the processing time model 352 and the transit time model 354, as described previously), including data representing at least one candidate delivery region, may be provided to the ML system. The ML system may be executed in order to obtain a prediction including at least one candidate delivery estimate for the at least one candidate delivery region.

In some examples, if the ML system is to be executed for multiple candidate delivery estimates, a higher priority candidate delivery region may be identified (e.g., a candidate delivery region corresponding to a more populous region may be higher priority than another candidate delivery region corresponding to a less populous region; a candidate delivery region associated with a demographics that is more likely to be doing online shopping may be considered a higher priority delivery region; a candidate delivery region in a time zone that is more likely to be awake may be considered a higher priority delivery region; etc.). Then the ML system may be executed to obtain candidate delivery estimate(s) for the higher priority candidate delivery region prior to obtaining candidate delivery estimate(s) for other lower priority candidate delivery regions. This may provide a technical advantage in that computing resources are used to execute the ML system to generate a predicted candidate delivery estimate that is more likely to be useful, thus reducing the latency for presenting a more likely useful (and thus higher priority) delivery estimate. This means that if the user navigates quickly from viewing a product to inputting their desired delivery region in a checkout interface, then at least the more likely useful candidate delivery estimate should already be generated by the ML system so that the checkout interface can be populated with the more likely candidate delivery estimate.

It should be noted that, if there are two or more candidate delivery regions determined at the operation 406, the operation 410 may be performed for a subset of the two or more candidate delivery regions and the operation 412 may be performed for a remainder of the two or more candidate delivery regions. In other words, the operation 408 may be performed using the operation 410 alone, the operation 412 alone, or a combination of the operations 410 and 412.

At an operation 414, candidate delivery estimate(s) that are not already stored in the cache may be stored in the cache. As previously discussed, each candidate delivery estimate may be stored with metadata to enable the candidate delivery estimate to be identified as corresponding to a candidate delivery region. Each candidate delivery estimate may be stored with a timestamp indicating the time it was generated, and stale candidate delivery estimates (e.g., generated one hour ago or older) may be automatically flushed from the cache. Thus, the cache may be kept up-to-date.

At an operation 416, input is received from the user device indicating a desired delivery region. For example, the user may input their shipping address in the checkout interface and the desired delivery region may be indicated by the shipping address (e.g., the desired delivery region may be the ZIP3 region indicated by the ZIP code of the shipping address, or may be the forward sortation area indicated by the postal code of the shipping address).

At an operation 418, at least one candidate delivery estimate is retrieved from the cache for an identified candidate delivery region that matches the desired delivery region. For example, after identifying the ZIP3 region from the user's shipping address, the cache may be queried for the candidate delivery estimate(s) corresponding to the identified ZIP3 region (and possibly also having the same online store identifier, same product identifier, same mail class, etc.) and any results matching the query may be retrieved.

At an operation 420, the retrieved candidate delivery estimate(s) are communicated to the user device, to cause the user device to present the retrieved candidate delivery estimate(s) in the checkout interface.

In some examples, the checkout interface may provide functionality that rely on the delivery estimate, such as cart splitting to group products by delivery date, dynamically ordering delivery options (e.g., different carriers) by speed of delivery, dynamically selecting a delivery option based on earliest delivery estimate, dynamically ordering delivery options based on certainty of the delivery estimate (e.g., based on the confidence score associated with a candidate delivery estimate predicted by the ML system), among other possibilities. Any functionality that relies on the delivery estimate may be automatically enabled and the checkout interface updated accordingly (if necessary) when the retrieved candidate delivery estimate(s) are presented in the checkout interface.

In some examples, if a user has an associated user profile or account, and there is already a shipping address stored for the user profile or account, the stored shipping address may be used as input to the ML system to generate candidate delivery estimates in addition to or instead of using the method described above. In some examples, the IP-based geolocation estimate and candidate delivery regions may be obtained (e.g., using the operations 402-406 described above) and compared to the delivery region of the stored shipping address. If the stored shipping address does not match any of the candidate delivery regions, then the method described above may be used to obtain candidate delivery estimates for the candidate delivery regions.

In some examples, the method described above may be used to obtain candidate delivery estimate(s) prior to presentation of the checkout interface on the user device. For example, candidate delivery estimate(s) prior may be obtained during or prior to presentation of a product page on the user device. For example, while or prior to a user viewing a product page for a particular product, the IP address associated with the user device may be obtained in order to obtain the geolocation estimate. Then, using the method described above, a delivery estimate may be obtained and presented on the product page (e.g., if there are multiple candidate delivery regions determined, then the delivery estimate corresponding to the highest priority candidate delivery region, such as the candidate delivery region having the highest population density, may be presented). In some examples, if there is only one candidate delivery region determined (e.g., the accuracy region happens to fall within one ZIP3 region) or all of the candidate delivery estimates are the same or approximately the same, then one candidate delivery estimate may be presented on the product page with fairly high confidence, prior to receiving input of the desired delivery region.

In various examples, the present disclosure provides a technical solution that enables dynamic generation of appropriate real-time data to populate a delivery estimate cache, without generating excessive and/or irrelevant data. Compared to other approaches that pre-generate and store delivery estimates, the examples described herein enable the cached delivery estimates to be dynamically generated, more up-to-date and thus more accurate. Because delivery conditions can change rapidly (e.g., weather-related, capacity related, etc.) and even hourly, it is important that the delivery estimates retrieved from the cache are up-to-date. Compared to yet other approaches that generate and store delivery estimates for all possible delivery destinations, examples described herein enable more efficient and effective use of computing resources to dynamically generate delivery estimates that are more likely to be useful. Using the IP-based geolocation as a basis for determining the candidate delivery regions that are used for generating delivery estimates means that computing resources are not wasted executing the ML system to generate estimates that likely will not be used.

Examples of the present disclosure enable appropriate delivery estimates to be retrieved from a cache and used to populate a checkout interface almost instantaneously when the user inputs their desired shipping address. This provides a more streamlined user experience and helps to ensure that the user is provided with full and accurate information on the checkout interface. Additionally, this enables other functionality of the checkout interface that depend on the delivery estimate to be enabled as soon as the desired shipping address is entered, rather than introducing further delay.

In some examples, cached delivery estimates are stored with metadata that enable reuse in other checkout sessions by other users. This may help to improve overall system efficiency by reducing the need to execute the ML system to generate new delivery estimates.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer system comprising:
a cache; and
a processing unit configured to execute computer-readable instructions to cause the computer system to:
obtain a geolocation estimate based on an IP address associated with a user device;
obtain, using a machine learning model, one or more candidate estimates for at least one candidate region overlapping with an accuracy region defined about the geolocation estimate;
store the obtained one or more candidate estimates in the cache;
responsive to receiving, from the user device, input indicating a desired region, retrieve from the cache at least one candidate estimate for an identified candidate region matching the desired region; and
communicate the at least one retrieved candidate estimate to the user device, to cause the user device to present the at least one retrieved candidate estimate in a checkout interface.

2. The computer system of claim 1, wherein the processing unit is configured to execute the instructions to further cause the computer system to determine the candidate regions by:
defining the accuracy region about the geolocation estimate by using the geolocation estimate as a center of the accuracy region and an accuracy margin extending from the center of the accuracy region to define a boundary of the accuracy region; and
identifying, as the at least one candidate region, at least one predefined region, from a set of predefined regions, that overlaps with the accuracy region.

3. The computer system of claim 2, wherein the processing unit is configured to execute the instructions to further cause the computer system to identify the at least one predefined region that overlaps with the accuracy region by:
identifying the at least one predefined region, from a set of predefined regions, whose boundary falls within or intersects with the boundary of the accuracy region.

4. The computer system of claim 2, wherein the processing unit is configured to execute the instructions to further cause the computer system to identify the at least one predefined region that overlaps with the accuracy region by:
identifying the at least one predefined region, from a set of predefined regions, whose representative location falls within the accuracy region.

5. The computer system of claim 2, wherein the processing unit is configured to execute the instructions to further cause the computer system to obtain the geolocation estimate by obtaining, from a third-party service provider, the geolocation estimate with the accuracy margin assigned by the third-party service provider.

6. The computer system of claim 2, wherein the accuracy margin is representative of a confidence level or accuracy of the geolocation estimate.

7. The computer system of claim 1, wherein the geolocation estimate is obtained prior to presentation of the checkout interface on the user device.

8. The computer system of claim 1, wherein the geolocation estimate is obtained during or prior to presentation of a product page on the user device, wherein the retrieved at least one candidate estimate presented in the checkout interface is related to of a product presented on the product page.

9. The computer system of claim 1, wherein the processing unit is configured to execute the instructions to further cause the computer system to obtain the one or more candidate estimates for the at least one candidate region by executing the machine learning system by:
inputting to the machine learning system a set of input data including data representing the at least one candidate region; and
obtaining a prediction from the machine learning system including the one or more candidate estimates.

10. The computer system of claim 9, wherein the processing unit is configured to execute the instructions to further cause the computer system to obtain candidate estimates for two or more candidate regions by:
identifying a higher priority candidate region from the two or more candidate regions; and
executing the machine learning system to obtain at least one candidate estimate for the higher priority candidate region prior to obtaining at least one candidate estimate for a remainder of the two or more candidate regions.

11. The computer system of claim 1, wherein the processing unit is configured to execute the instructions to further cause the computer system to obtain at least one candidate estimate by:
retrieving, from the cache, the at least one candidate estimate, the retrieved at least one candidate estimate being previously obtained using the machine learning system.

12. The computer system of claim 1, wherein the one or more candidate estimates are one or more candidate delivery estimates, the at least one candidate region is at least one candidate delivery region, and the desired region is a desired delivery region.

13. A computer implemented method comprising:
obtaining a geolocation estimate based on an IP address associated with a user device;
obtaining, using a machine learning model, one or more candidate estimates for at least one candidate region overlapping with an accuracy region defined about the geolocation estimate;
storing the obtained one or more candidate estimates in a cache;
responsive to receiving, from the user device, input indicating a desired region, retrieving from the cache at least one candidate estimate for an identified candidate region matching the desired region; and
communicating the at least one retrieved candidate estimate to the user device, to cause the user device to present the at least one retrieved candidate estimate in a checkout interface.

14. The method of claim 13, further comprising determining the candidate regions by:
defining the accuracy region about the geolocation estimate by using the geolocation estimate as a center of the accuracy region and an accuracy margin extending from the center of the accuracy region to define a boundary of the accuracy region; and
identifying, as the at least one candidate region, at least one predefined region, from a set of predefined regions, that overlaps with the accuracy region.

15. The method of claim 14, wherein identifying the at least one predefined region that overlaps with the accuracy region comprises:
identifying the at least one predefined region, from a set of predefined regions, whose boundary falls within or intersects with the boundary of the accuracy region.

16. The method of claim 14, wherein identifying the at least one predefined region that overlaps with the accuracy region comprises:
identifying the at least one predefined region, from a set of predefined regions, whose representative location falls within the accuracy region.

17. The method of claim 14, wherein obtaining the geolocation estimate comprises:
obtaining, from a third-party service provider, the geolocation estimate with the accuracy margin assigned by the third-party service provider.

18. The method of claim 13, wherein obtaining the one or more candidate estimates for the at least one candidate region comprises executing the machine learning system by:
inputting to the machine learning system a set of input data including data representing the at least one candidate region; and
obtaining a prediction from the machine learning system including the one or more candidate estimates.

19. The method of claim 18, wherein candidate estimates are obtained for two or more candidate regions by:
identifying a higher priority candidate region from the two or more candidate regions; and
executing the machine learning system to obtain at least one candidate estimate for the higher priority candidate region prior to obtaining at least one candidate estimate for a remainder of the two or more candidate regions.

20. The method of claim 13, further comprising obtaining at least one candidate estimate by:
retrieving, from the cache, the at least one candidate estimate, the retrieved at least one candidate estimate being previously obtained using the machine learning system.

21. A non-transitory computer readable medium having instructions stored thereon, wherein the instructions are executable by a processing unit of a computer system to cause the computer system to:
obtain a geolocation estimate based on an IP address associated with a user device;
obtain, using a machine learning model, one or more candidate estimates for at least one candidate region overlapping with an accuracy region defined about the geolocation estimate;
store the obtained one or more candidate estimates in the cache;
responsive to receiving, from the user device, input indicating a desired region, retrieve from the cache at least one candidate estimate for an identified candidate region matching the desired region; and
communicate the at least one retrieved candidate estimate to the user device, to cause the user device to present the at least one retrieved candidate estimate in a checkout interface.
